(19) United States
(12) Patent Application Publication
(10) Pub. No.: US 2025/0232296 A1
(43) Pub. Date: Jul. 17, 2025

(54) TRANSACTION KEY GENERATION

(71) Applicant: MASTERCARD INTERNATIONAL INCORPORATED, Purchase, NY (US)

(72) Inventors: Ian David Alan MADDOCKS, Milton Keynes (GB); Cristian RADU, Beauvechain (BE)

(21) Appl. No.: 18/705,436

(22) PCT Filed: Sep. 19, 2022
(86) PCT No.: PCT/US2022/043979

§ 371 Date: Apr. 26, 2024

(30) Foreign Application Priority Data
Oct. 29, 2021 (GB) 2115596.5

(51) Int. Cl. G06Q 20/38; G06Q 20/36; G06Q 20/40; H04L 9/08; H04L 9/14

(52) U.S. Cl. CPC G06Q 20/3829; G06Q 20/36; G06Q 20/401; H04L 9/0836; H04L 9/14

(57) ABSTRACT

A method of deriving an issuer master key in a transaction system, cryptographic keys within the transaction system being configured within a hierarchical structure with a system level key (SLK) at a top level of the hierarchical structure, the method comprising: receiving, at the transaction system, issuer derivation data associated with an issuer; deriving the issuer master key from the system level key using the received issuer derivation data, the issuer master key being at a lower level within the hierarchical structure than the system level key.

### CROSS REFERENCE TO RELATED APPLICATION

This application claims the benefit of United Kingdom Patent Application No. 2115596.5, which was filed on Oct. 29, 2021, the entire contents of which are hereby incorporated by reference for all purposes.

### TECHNICAL FIELD

The present disclosure relates to transaction key generation. In particular, aspects of the present disclosure relate to a method of deriving an issuer master key in a transaction system, a transaction system for deriving an issuer master key, a method of authenticating a payment device transaction in a transaction system, a transaction system for authenticating a payment device transaction, a method of digitising a payment device within a transaction system using a digital enablement system and a digital enablement system for digitising a payment card.

### BACKGROUND

There are technical challenges in providing a transaction infrastructure to provide transaction services to a large number of clients. One particular challenge arises in the maintenance and processing of issuer master keys which are used to derive session keys for use in individual transactions and to provision credentials onto payment devices (either physical cards or digital wallets/digital cards). In one specific example the applicant's Mastercard Cloud Based Payment (MCBP) architecture supports a digital enablement system in which a centralised token vault stores thousands of issuer master keys.

Any changes to the transaction architecture, e.g. the onboarding of a new issuer or a change in the services that an issuer provides for its customers (resulting in for example a splitting of account ranges at the issuer end), can result in the addition of further issuer master keys to the transaction architecture.

Storing greater numbers of issuer master keys on the system can reduce the responsiveness of the system which is undesirable when wishing to run a real-time platform. Additionally, as the number of issuer master keys increases additional Host Secure modules (computing devices that safeguard and manage digital keys) are required to store the keys. Further, where redundant hardware modules are used to store cryptographic keys the burden of managing such redundancy modules increases as the number of keys increases.

The present disclosure has been devised to mitigate or overcome at least some of the above-mentioned problems.

### SUMMARY OF THE DISCLOSURE

According to a first aspect of the present disclosure, there is provided a method of deriving an issuer master key in a transaction system, cryptographic keys within the transaction system being configured within a hierarchical structure with a system level key (SLK) at a top level of the hierarchical structure, the method comprising: receiving, at the transaction system, issuer derivation data associated with an issuer; deriving the issuer master key from the system level key using the received issuer derivation data, the issuer master key being at a lower level within the hierarchical structure than the system level key.

The present disclosure provides a method for deriving issuer master keys (IMKs) from a system level key that is held in the transaction system. Cryptographic keys (e.g. issuer master key, (card) master keys and session keys) form a hierarchical structure and the system level key is at the top of this hierarchical structure (above the issuer master keys).

The IMK for a particular issuer may be derived from the system level key in conjunction with issuer derivation data that is received either during a transaction of a payment device (card) or as part of provisioning a payment device into a digital wallet.

According to the method of the present disclosure therefore the transaction system may avoid the need to store issuer master keys for each issuer since these keys may be derived on the fly from the issuer derivation data and the system level key.

The transaction system may comprise a digital enablement system having a key management system, the key management system being arranged to store the system level key and derive issuer master keys from the stored system level key using the issuer derivation data.

The transaction system may provide the infrastructure required to operate a payment device (card) scheme and to provide for routing of transactions between acquirers and issuers. To support the tokenisation of payment devices there may be provide a digital enablement system that supports the performance of tokenised digital transactions. The digital enablement system may further comprise a key management system for the storage of the system level key and derivation of the various further cryptographic keys (IMKs, card master keys and session keys).

Deriving the issuer master key may comprise generating an issuer master key derivation data string and encrypting the data string with the system level key. The issuer derivation data may be processed to extract the data needed to derive the issuer master key. Such extracted data may be arranged in a data string and then encrypted with the system level key.

The transaction system may comprise more than one system level key, each system level key being associated with a system level key version number and wherein the issuer derivation data comprises a bank identification number (BIN) and the system level key version number.

The transaction system may be arranged to update its system level key periodically and consequently the version number of the system level key may be provided in order to allow the issuer master key to be derived. The bank identification number (BIN) for the payment device may also form part of the issuer derivation data that is used to derive the issuer master key. It is noted that the BIN may be derived from the primary account number (PAN) of the payment device and, as such, the PAN may form part of the issuer derivation data that is received by the transaction system.

The issuer derivation data may further comprise a parameter indicating the length of the BIN. As noted above the issuer derivation data may comprise the PAN from which the BIN may be derived.

The issuer derivation data may additionally contain a parameter that indicates BIN length. To enable the issuer master key to be derived successfully, the issuer master key derivation data string may be required to be of a known length and, depending on the length of the BIN, may require some padding data to be added in order for the data string to be of a standardised length.

Conveniently, the system level key version number and the parameter indicating the length of the BIN may be combined into a single value, a key derivation index parameter and the issuer derivation data may comprise the key derivation index parameter.

A key type identifier may be used to identify the type of transaction that the payment device is being used for. The issuer derivation data may comprise a key type identifier, the key type identifier identifying the type of transaction being undertaken within the transaction system by the cardholder payment device.

The issuer master key derivation data string may be 16 bytes long, the first 8 bytes of the string comprising: the key type identifier, the BIN length parameter, the BIN and padding data and the second 8 bytes of the string being the inverse of the first 8 bytes.

The hierarchical structure of cryptographic keys within the transaction system may comprise: the system level key; issuer master keys derived from the system level key; payment device master keys derived from issuer master keys; session keys derived from payment device master keys.

According to a further aspect of the present disclosure there is provided a transaction system for deriving an issuer master key, cryptographic keys within the transaction system being configured within a hierarchical structure with a system level key (SLK) at a top level of the hierarchical structure, the system comprising: an input arranged to receive issuer derivation data associated with an issuer;
a key management system arranged to derive the issuer master key from the system level key using the received issuer derivation data, the issuer master key being at a lower level within the hierarchical structure than the system level key.

According another aspect of the present disclosure there is provided a method of authenticating a payment device transaction in a transaction system, the transaction system comprising a digital enablement system having a key management system, cryptographic keys within the transaction system being configured within a hierarchical structure with a system level key (SLK) at a top level of the hierarchical structure, the method comprising: receiving transaction data, the transaction data comprising issuer derivation data associated with an issuer, and a transaction cryptogram; deriving an issuer master key for the issuer from the system level key and the received issuer derivation data according to the method of the first aspect of the disclosure; deriving a payment card Master Key using received transaction data and the derived issuer master key; in the event that the transaction is an EMV transaction: deriving a session key using the received transaction data and the derived payment card master key; generating a transaction cryptogram using the received transaction cryptogram using the session key; and in the event that the transaction is a contactless magstripe transaction: generating a transaction cryptogram based on an application transaction counter (ATC) extracted from the received transaction data; authenticating the transaction if the received transaction cryptogram matches the generated transaction cryptogram.

The transaction data may comprise: a primary account number (PAN), a PAN sequence number (PSN) and a key derivation index (KDI), the KDI indicating a system level key version number in use within the transaction system and a Bank Identification Number length parameter. The PAN and KDI may form the issuer derivation data used to derive the issuer master key according to the method of the first aspect of the present invention.

The transaction data may further comprise: Card Risk Management Data Object List 1 (CDOL1) and CDOL data items for EMV transactions, and track data for contactless mag stripe transaction.

According to a still further aspect of the present disclosure there is provided a transaction system for authenticating a payment device transaction in a transaction system, the transaction system comprising a digital enablement system having a key management system, cryptographic keys within the transaction system being configured within a hierarchical structure with a system level key (SLK) at a top level of the hierarchical structure, the system comprising: an input arranged to receive transaction data, the transaction data comprising issuer derivation data associated with an issuer, and a transaction cryptogram; a digital enablement system having a key management system arranged to: derive an issuer master key for the issuer from the system level key and the received issuer derivation data according to the method of the first aspect of the disclosure; derive a payment card Master Key using received transaction data and the derived issuer master key; and in the event that the transaction is an EMV transaction: derive a session key using the received transaction data and the derived payment card master key; and generate a transaction cryptogram using the received transaction cryptogram using the session key; or in the event that the transaction is a contactless magstripe transaction: generate a transaction cryptogram based on an application transaction counter (ATC) extracted from the received transaction data; authenticate the transaction if the received transaction cryptogram matches the generated transaction cryptogram

According to a yet further aspect of the present disclosure there is provided a method of digitising a payment device within a transaction system using a digital enablement system having a key management system, cryptographic keys within the transaction system being configured within a hierarchical structure with a system level key (SLK) at a top level of the hierarchical structure and the payment device having been issued by an issuer, the method comprising: receiving payment device data, the payment device data comprising a primary account number (PAN) for the payment device; deriving an issuer master key for payment device according to the method of the first aspect of the present disclosure; deriving a card key using the issuer master key and the PAN of the payment device; associating, in the digital enablement system, the payment device with the derived card key; provisioning the derived card key into a digital wallet.

According to a yet still further aspect of the present disclosure there is provided digital enablement system for digitising a payment card, cryptographic keys within the digital enablement system being configured within a hierarchical structure with a system level key (SLK) at a top level of the hierarchical structure and the payment device having been issued by an issuer, the digital enablement system comprising: an input arranged to receive payment device data, the payment device data comprising a primary account number (PAN) for the payment device; a key management system arranged to: derive an issuer master key for payment device according to the method of the first aspect of the disclosure; derive a card key using the issuer master key and the PAN of the payment device; wherein the digital enablement system is arranged to associate the payment device with the derived card key and to provision the derived card key into a digital wallet.

According to a yet further aspect of the present disclosure, there is provided a computer program product comprising instructions which, when the program is executed by a computer, cause the computer to carry out the above methods of the present disclosure.

According to a still further aspect of the present disclosure, there is provided a computer-readable storage medium comprising instructions which, when executed by a computer, cause the computer to carry out the above methods of the present disclosure.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the disclosure will now be described, by way of example only, with reference to the accompanying drawings, in which:

FIG. 1 shows a known four-party transaction scheme;

FIG. 2 shows a transaction architecture according to an embodiment of the disclosure appropriate for interaction between a cardholder and a merchant;

FIG. 3 shows a known process of onboarding a new issuer to a transaction system;

FIG. 4 shows the process of creating cryptographic keys in accordance with an embodiment of the present invention;

FIG. 5 shows a hierarchy of cryptographic keys in accordance with an embodiment of the present invention;

FIG. 6 shows the process of processing a transaction in accordance with an embodiment of the present invention.

### DETAILED DESCRIPTION

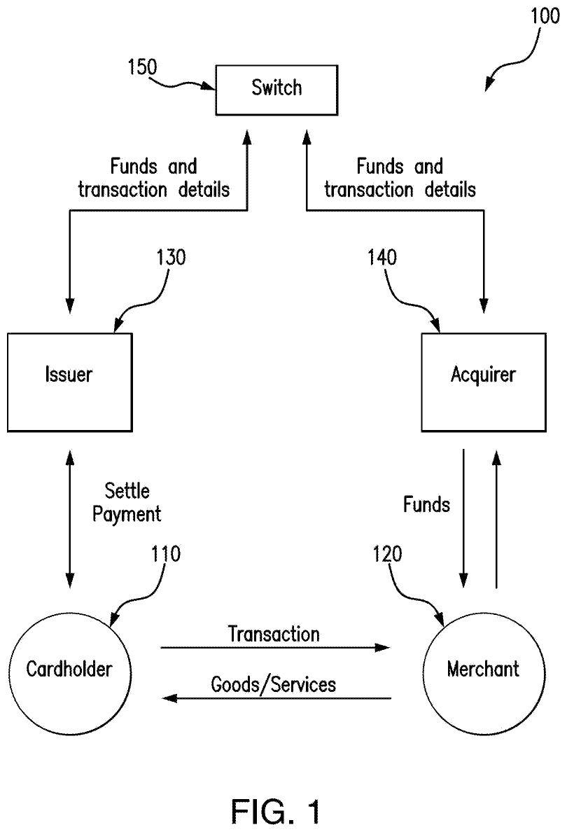

FIG. 1 is a block diagram of a typical four-party model or four-party payment transaction scheme. The diagram illustrates the entities present in the model and the interactions occurring between entities operating in a card scheme.

Normally, card schemes—payment networks linked to payment cards—are based on one of two models: a three-party model or a four-party model (adopted by the present applicant). For the purposes of this document, the four-party model is described in further detail below.

The four-party model may be used as a basis for the transaction network. For each transaction, the model comprises four entity types: cardholder 110, merchant 120, issuer 130 and acquirer 140. In this model, the cardholder 110 purchases goods or services from the merchant 120. The issuer 130 is the bank or any other financial institution that issued the card to the cardholder 110. The acquirer 140 provides services for card processing to the merchant 120.

The model also comprises a central switch 150—interactions between the issuer 130 and the acquirer 140 are routed via the switch 150. The switch 150 enables a merchant 120 associated with one particular bank acquirer 140 to accept payment transactions from a cardholder 110 associated with a different bank issuer 130.

A typical transaction between the entities in the four-party model can be divided into two main stages: authorisation and settlement. The cardholder 110 initiates a purchase of a good or service from the merchant 120 using their card. Details of the card and the transaction are sent to the issuer 130 via the acquirer 140 and the switch 150 to authorise the transaction. The cardholder 1 10 may have provided verification information in the transaction, and in some circumstances may be required to undergo an additional verification process to verify their identity (such as 3-D Secure in the case of an online transaction). Once the additional verification process is complete the transaction is authorised.

On completion of the transaction between the cardholder 110 and the merchant 120, the transaction details are submitted by the merchant 120 to the acquirer 140 for settlement. The transaction details are then routed to the relevant issuer 130 by the acquirer 140 via the switch 150. Upon receipt of these transaction details, the issuer 130 provides the settlement funds to the switch 150, which in turn forwards these funds to the merchant 120 via the acquirer 140.

Separately, the issuer 130 and the cardholder 110 settle the payment amount between them. In return, a service fee is paid to the acquirer 140 by the merchant 120 for each transaction, and an interchange fee is paid to the issuer 130 by the acquirer 140 in return for the settlement of funds.

In practical implementations of a four-party system model, the roles of a specific party may involve multiple elements acting together. This is typically the case in implementations that have developed beyond a contact-based interaction between a customer card and a merchant terminal to digital implementations using proxy or virtual cards on user computing devices such as a smart phone.

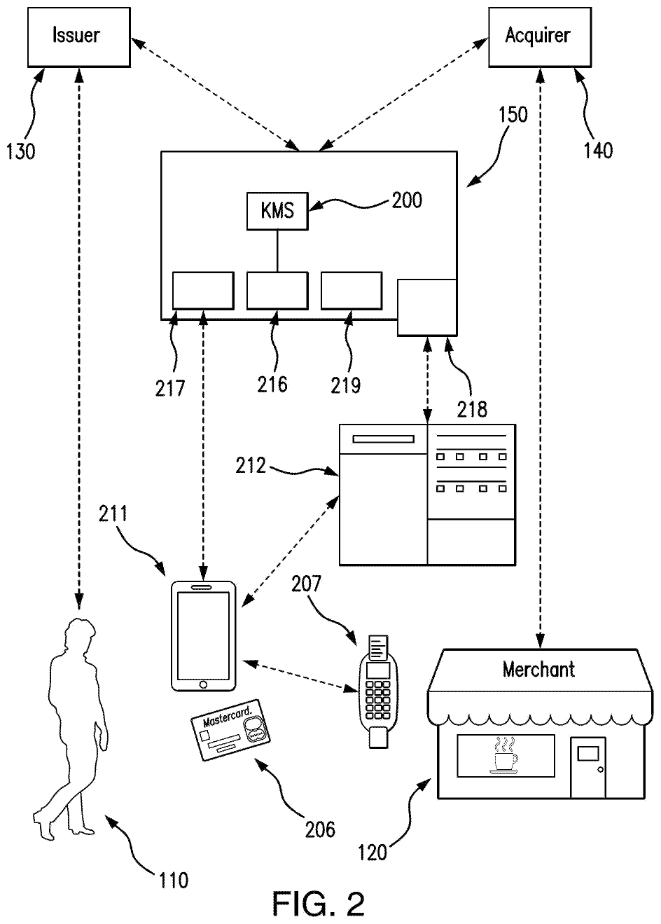

FIG. 2 shows an architecture according to an embodiment of the disclosure appropriate for interaction between a cardholder and a merchant. This Figure shows a general purpose architecture for reference, but shows in particular elements of an architecture used when a cardholder carries out an online transaction with a merchant server.

For a conventional transaction, a cardholder will use their payment card 206—or a mobile computing device such as smartphone 211 adapted for use as a contactless payment device—to transact with a POS terminal 207 of a merchant 120.

However, the cardholder may also use their computing device—which may be any or all of a mobile telephone handset, a tablet, a laptop, smartwatch or wearable or any other suitable computing device (in FIG. 2 a mobile telephone or smartphone 211 is shown)—to act either as a proxy for a physical payment card 206 or as a virtual payment card operating only in a digital domain. The smartphone 211 may achieve this with a mobile payment application and a digital wallet, as described below. The smart phone 211 can use this to transact with a merchant POS terminal 207 using NFC or another contactless technology, or to make a payment in association with its wallet service as discussed below. The cardholder may also interact with the merchant via online transactions. To make an online transaction, the smartphone 211 may also be able to interact with a merchant server 212 representing the merchant 120 over any appropriate network connection, such as the public internet—the connection to the merchant may be provided by an app or application on the computing device.

The transaction system 150 provides computing infrastructure necessary to operate the card scheme and also provides for routing of transactions and other messaging to parties such as the acquirer 140 and the issuer 130. The transaction system also provides a wallet service 217 to support a digital wallet on the cardholder computing device, and an internet gateway 218 to accept internet-based transactions for processing by the transaction infrastructure. In other embodiments, the wallet service 217 may be provided similarly by a third party with an appropriate trust relationship with the transaction scheme provider. To support tokenisation, a token service provider 219 is present (again, this is shown as part of transaction infrastructure 150 but may be provided by a third party with appropriate trust relationships), and the transaction scheme infrastructure provides a digital enablement service/system 216 to support the performance of tokenised digital transactions, and to interact with other elements of the system to allow transactions to be performed correctly—this digital enablement service may include other elements, such as token service provision.

For a tokenised transaction, the transaction is validated in the transaction scheme by mapping the cardholder token to their card PAN, checking the status of the token (to ensure that it is in date and otherwise valid) and any customer verification approach used. This allows the issuer to authorise the transaction in the normal manner.

The digitisation enablement service 216 is arranged to provision account credentials and cryptographic keys to a digital wallet app on the user device 211. Such a digital wallet app (which includes a secure/trusted environment) is provisioned with token data relating to the transaction card 6 that has been digitised from the digitisation enablement service 216 via the digital wallet service 217. A key management system (KMS) 200 is a sub-component of the digital enablement system 216 which, as described below, provides cryptographic keys to the digital enablement system 216.

Existing procedures for credential management in payment systems are centralized—any request to create or validate credentials results in a query to a centralized system (the digital enablement system 216 through the key management system 200). For a payment system implementing EMV standards, credentials are generated using keys derived according to a hierarchical process. Issuer Master Keys (IMK) are associated with a specific range of tokens, and keys for use for credentials are derived hierarchically (card Master Keys—MK—from IMK, and then Session Keys—SK—from MK). This approach is used for devices, such as physical cards, but is also used for digital transactions. The number of digital transactions is increasing extremely rapidly, as opposed to device-based interactions where the growth is more consistent with resources.

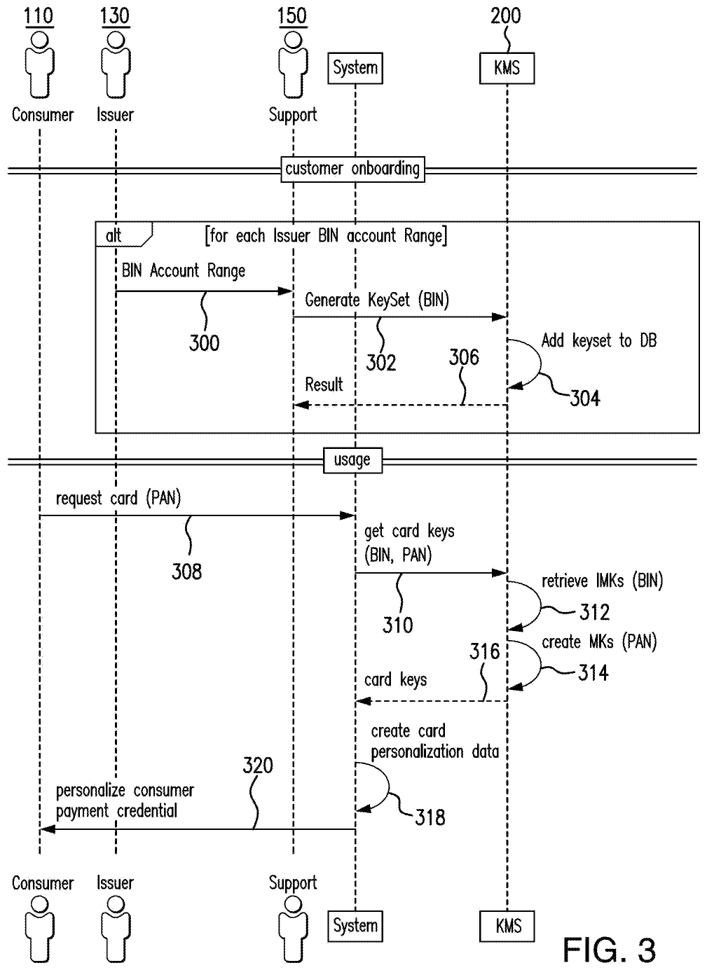

FIG. 3 shows the known process of onboarding a new issuer to a transaction system.

In step 300, the issuer 130 provides a BIN (Bank identification number) account range to the transaction system 150. In case the key management system 200 (KMS), component of the transaction system 150, is manually operated, the customer onboarding flow will be executed by a Support Operator on behalf of the KMS/transaction system. Usually, this role is fulfilled by a security administrator with rights of creating new set of keys for a new customer (e.g., issuer 130), or for an existing customer that adds supplementary account ranges to its set of operational account ranges. In step 302 the transaction system 150 (through its KMS component 200) generates a set of cryptographic keys based on the data received in step 300. The set of keys comprises an issuer master key (IMK). The set of keys is added to a key management system (abbreviated in the FIGS. 2, 3, and 4, as KMS 200) which is linked to/used by the digitisation enablement system 216 in FIG. 2. The key management system 200 returns a message back to the transaction system 150 in step 306 that the key set has been added to its database.

The above customer onboarding process (300-306) is repeated whenever an issuer 130 (who is already known to the transaction system 150) partitions its range of account numbers (e.g. to provide different services to different cardholders) and whenever a new issuer is added to the transaction system.

Once the issuer master keys have been created the issuer 130 may subsequently use them to issue a payment card with a primary account number (PAN) to a cardholder/consumer 110 (see the “usage” section of FIG. 3 for further details). If the cardholder wishes to digitize their physical payment card 206 onto a particular form factor (e.g. Apple® Pay on their smartphone 211) then in step 308 a request is sent from the smartphone 211 to the transaction system 150 to create a token and map it to the PAN, and then personalise the token in the payment card 206 or other form factor of the consumer.

The transaction system 150 then sends a request in step 310 to the key management system (KMS) 200 for the generation of the (card) master keys related to the payment card 206, which are diversified from the issuer master key. As part of this request the transaction system sends both the BIN of the account range of the PAN related to the payment device 206 and the PAN itself of the payment card digitized in the device 206 to the KMS 200.

In step 312 the database within the KMS 200 is searched for the issuer master key related to the provided BIN range (it is noted that the KMS 200 retrieves a unique issuer master key based on the provided account's BIN) and in step 314 master keys for the payment card are created via a key diversification process using the retrieved issuer master key and the provided PAN. The created (card) master key is created in an “on the fly” process. It is noted that since created master key is reproducible there is no need to store the derived keys.

Key diversification is a cryptographic technique by which a master key is used together with unique input to create one or more secondary keys.

Within FIG. 3, the key management system 200 diversifies the (card) master key CARDMK from the retrieved issuer master key IMK, such that

card MK:=F(PAN+PSN,IMK),

where PAN is the primary account number for the card and PSN is the PAN sequence number (which identifies and differentiates cards with the same PAN).

In step 316 the derived master key for the payment card 206 is returned to the transaction system 150, which includes it together with other parameters required for the card application's operation into a card personalization data block in step 318. This card data block is further encrypted as a card data stream with key material synchronized with the target form factor which initiated the demand (308) and personalised on to the form factor, e.g. Apple® Pay, in step 320.

It is noted the card Master Key that has been personalised onto the cardholder's selected form factor is used during transactions to generate session keys (SK):

EMV SK:=F(ATC,card MK).

where the ATC is an application transaction counter which is a value held that is incremented by the payment device each time a transaction is initiated.

An EMV payment cryptogram may also be generated according to F(transaction data, SK). Contactless magstripe payment cryptograms do not have a session key but may be generated as F(ATC, KdCVC), where kdCVC is the key type for a dynamic CVC.

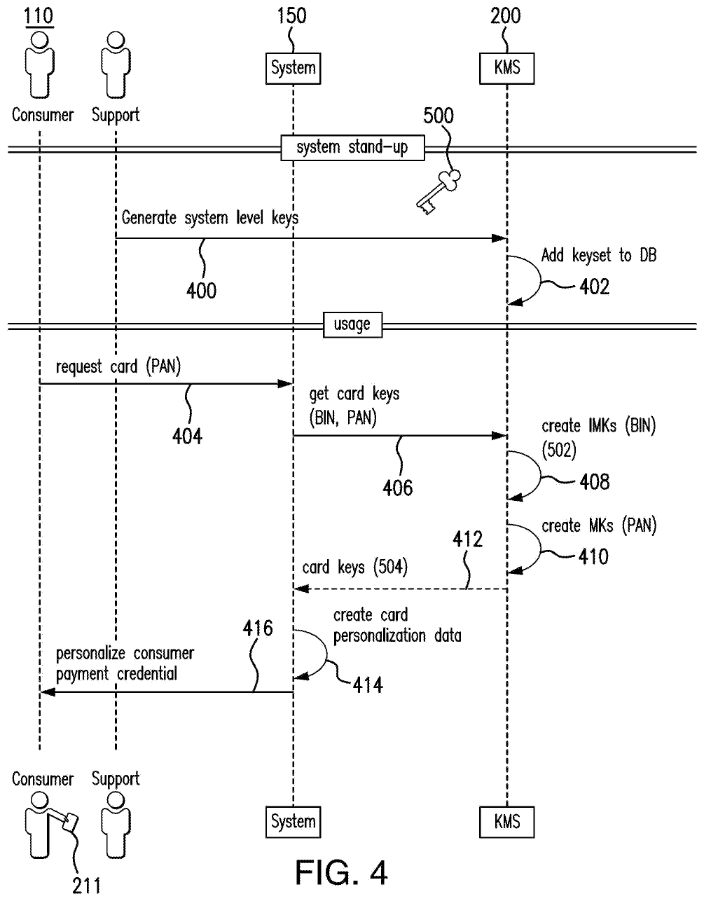

FIG. 4 shows the process of creating cryptographic keys in accordance with an embodiment of the present disclosure in the context of digitising a payment card 206 onto a smartphone 211.

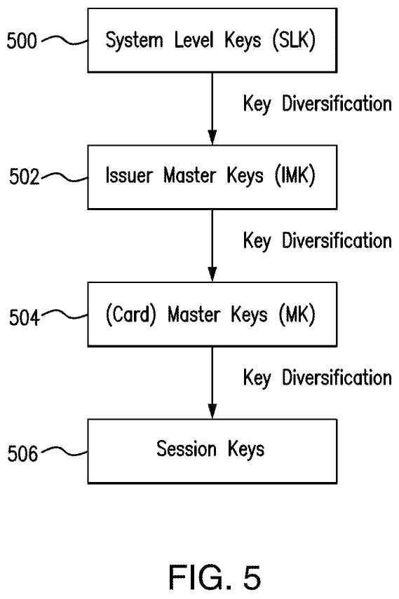

As the transaction system is deployed a system level key 500 is generated in step 400 by the key management system (200). This system level key is arranged to sit above issuer master keys (IMKs) in the hierarchy of cryptographic keys such that the hierarchy, as also shown in FIG. 5, comprises:
Top level-system level keys 500
Issuer master keys (IMKs) 502 in the next level down which are derived from the system level keys
(Card) master keys (MKs) 504 at the next level of the hierarchy which are derived from issuer master keys
Session keys 506 at the bottom level of the hierarchy which are derived from the master keys (MK)

In step 402 the system level key 500 is added to the key management system's 200 database along with a key derivation index (KDI) parameter which indicates the version of the system level key 500 being used within the transaction system 150. It is expected that the system level key may be refreshed over time and the KDI parameter is used to identify which version of the system master key is to be used to derive issuer master keys.

In use, if a cardholder 110 wishes to personalise their physical payment card 206, which comprises a primary account number (PAN), onto a particular form factor (e.g. Apple® Pay on their smartphone 211) then in step 404 a request is sent from the smartphone 211 to the transaction system 150 to personalise the payment card. The request comprises issuer derivation data associated with the issuer 130 and the cardholder's payment device 206. The issuer derivation data comprises BIN related to the payment device. As noted above, FIG. 4 relates to the digitisation of the payment card 206 onto a smartphone 211 form factor. As such it is the PAN for the payment device that is actually received by the transaction system 150 in step 404 and the BIN related to the payment device 206 is then extracted from the PAN.

The transaction system 150 then sends a request in step 406 to the key management system (KMS) 200 for the cryptographic keys (issuer master key 502 and (card) master keys 504 related to the payment card 206). As part of this request the transaction system sends the received issuer derivation data to the KMS 200. As noted above the issuer derivation data comprises the BIN related to the payment device 206. The request also comprises the PAN for the payment device. It is the BIN that is used to derive the issuer master key 502 whereas the PAN is used one level down in the cryptographic key hierarchy to derive the (card) master key from the issuer master key.

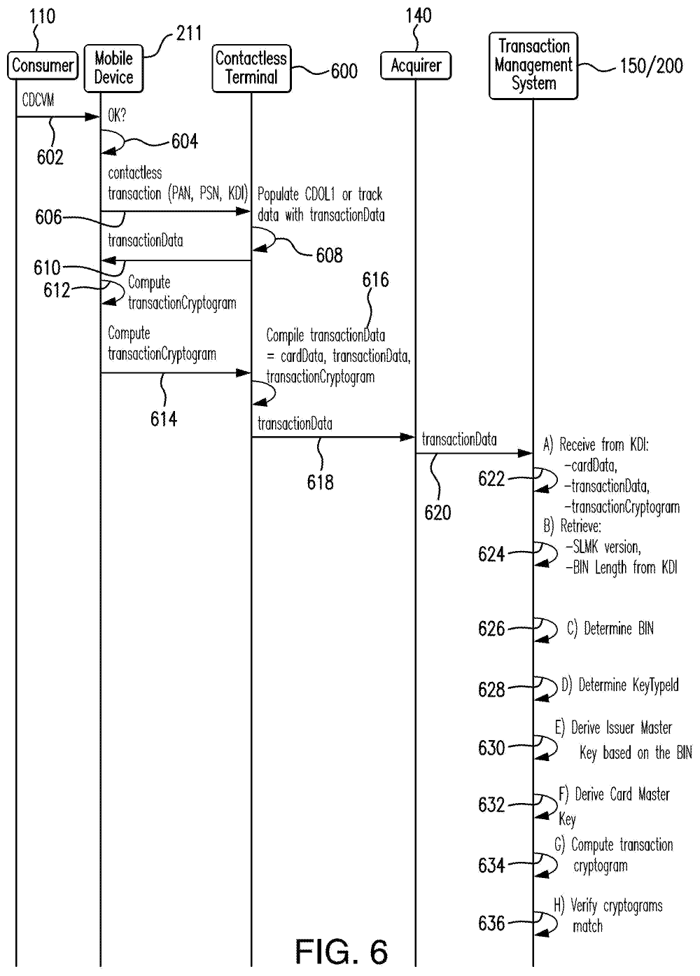

In step 408 the KMS 200 retrieves the system level key 500 and then derives the issuer master key, in a key diversification process based on issuer's BIN, in dependence on the BIN data contained in the request and the system master key. It is noted that in contrast to step 312 in FIG. 3 the issuer master keys (IMKs) relating to the issuer associated with the payment device is derived on the fly rather than being retrieved from the KMS's database. It is noted that in step 408 different issuer master keys may separately be derived from the system level key for EMV services (e.g. application cryptogram, secure messaging confidentiality, secure messaging integrity) and for contactless magstripe services (KdCVC). These different key types may then all be personalised onto the user form factor. During a transaction (see step 628 in FIG. 6 below) data relating to the type of transaction being undertaken may be supplied as part of the issuer derivation data to enable a key type identifier to be derived and therefore the correct IMK key type to be derived).

In step 410 master keys 504 for the payment card are created via a key diversification process using the created issuer master key 502 and the provided PAN. The created master key 504 is created in an “on the fly” process by the KMS 200. It is noted that since created master key is reproducible there is no need to store the derived keys.

In step 412 the derived master key for the payment card 206 is returned to the transaction system 150, which includes it together with other parameters required for the card application's operation into a card personalization data block in step 414. This card data block is further encrypted as a card data stream with key material synchronized with the target form factor which initiated the demand (404) and personalised on to the form factor, e.g. Apple® Pay, in step 416

According to embodiments of the present disclosure a key diversification strategy is used to form the Issuer Master Key (IMK) 502 from the system level key 500 and the IMK that is formed may then be further diversified into card keys 504 and session keys 506.

The current process of diversifying a card master key (MK) from an issuer master key (IMK) is described above in relation to step 314. In comparison to the process shown in FIG. 3, embodiments in accordance with the present invention add an additional stage (step 408 above) to this diversification process, which is now described in more detail. In step 408, the key management system 200 takes the system level key (SLK) 500 and generates the Issuer Master Key (IMK) from the system level key 500 and issuer derivation data in the form of BIN account number and a key derivation index (KDI) parameter.

IMK=F(derivation data;system level key)

where SLK and length of derivation data is identified to the transaction system by the KDI.

In more detail it is noted that the payment device Key Derivation Index (KDI) parameter may be encoded as KDI=(SLKVn|BINLen),
where
   System level key version number—SLKVn [1n]
   BIN account number length—BINLen [1n]

The derivation data may then be encoded as;
KeyTypeId [1B]|BinLen [1B]|BIN [3 . . . 11n]|padding [1 . . . 9n]
   where the “KeyTypeID” is the type of key that is to be derived (see, for example, Table 1 below which shows KeyTypeID versus Key Type), “BinLen” is the length of the BIN account number, “BIN” is the actual BIN account number and “padding” is padding data that is needed to bring the derivation data up to 16 bytes (it is note that the AES128 encryption algorithm uses input blocks of 16 bytes).

TABLE 1

| KeyTypeId | Key Type |
|---|---|
| 01 | KdCVC (dynamic CVC) |
| 02 | IMKac (Application Cryptogram) |
| 03 | IMKsmc (secure messaging confidentiality) |
| 04 | IMKsmi (secure messaging integrity) |

An example of the derivation of an issuer master key for an application cryptogram is shown below:
SLKVn=01 (this is the version number of the system level key held by the KMS 200 within the transaction system 150)
BINLen=8
BIN=51234567
KDI=18 (SMKVn|BIN Len)
Key TypeId=02
IMKac derivation data string=(key type ID)(BIN length)(BIN)(padding)|inverse=02 08 51234567FFFF|
   FDF7AEDCBA980000
IMKac=AES128 encryption of (020851234567FFFFFDF7AEDCBA980000) using SLK

[In the above IMKac derivation data string it is noted that “FDF7AEDCBA980000” represents the inverted bits of the hex encoded input (02 08 51234567FFFF)]

It is noted that, although FIG. 4 is presented in the context of provisioning a payment card 206 onto a form factor, the same process of deriving the issuer master keys 502 from the system level key 500 on the basis of received derivation data may also apply to the authentication of a transaction in a transaction system that comprises a system level key (SLK). In such authentication, the method of authentication comprises verifying a transaction cryptogram as proof of payment.

FIG. 6 shows a transaction between a contactless terminal 600 and a mobile device 211 which has a payment card 206 provisioned upon it according to the process described above in FIG. 4.

In step 602 a cardholder/consumer 110 enters card holder verification data (e.g. PIN or biometric data) into their mobile device 211 as part of the transaction at the contactless terminal 600. In step 604 the mobile device 211 checks the verification data and, assuming it is verified, moves to step 606 in which the contactless transaction is initiated with the contactless terminal 600. It is noted that the Primary Account Number (PAN), PAN Sequence Number (PSN) and Key Derivation Index (KDI) are sent to the contactless terminal 600 in this step.

In step 608 the terminal 600 populates a list of data that the card 206 provisioned on the mobile device 211 requires (Card risk management data object list—CDOL data) and this transaction data is returned to the mobile device 211 in step 610. In step 612 a transaction cryptogram is computed by the mobile device 211 and this is sent to the terminal 600 in step 614.

In step 616 the terminal compiles transaction data comprising payment card 206 data, data related to the transaction and the received transaction cryptogram and sends this data, in step 618 to the acquirer 140 who then forwards it in step 620 to the transaction system 150 (including the key management system 200).

The transaction system 150 receives the transaction data in step 622. As noted above the received transaction data comprises the transaction cryptogram that was generated in the transaction between the contactless terminal 600 and the mobile device 211. This transaction cryptogram is to be verified as part of the authentication process of FIG. 6. Also received by the transaction system is card data (e.g. PAN, PSN and KDI) and data related to the transaction (e.g. CDOL1 data items for EMV transactions and track data for contactless magnetic stripe transactions).

In step 624 the transaction system 150/key management system 200 uses the received KDI to retrieve the system level key (SLK) version number and the length of the BIN account number. The SLMK version number may be encoded as the left most nibble of the KDI and the BIN length as the right most nibble of the KDI (see example above with the KDI=18. This translates as SLK version number 1 and a BIN length of 8 digits).

In step 626 the transaction system 150/key management system 200 determines the BIN (i.e. issuer derivation data) as the “n” left most digits of the PAN, where n is the BIN length (i.e. “8” in the above example).

In step 628, the identifier of the key type (KeyTypeID) is determined by the transaction system 150/key management system 200. For an EMV transaction the KeyTypeID=02 (EMV Application Crpytogram) and for contactless magstripe transactions the KeyTypeID=01 (KdCVC). It is noted that the issuer derivation data may include data relating to the type of transaction being undertaken, e.g. a contactless magstripe transaction or an EMV based transaction between the payment card 206 and a point of sale (POS). The data relating to the type of transaction enables the appropriate issuer master key to be derived in step 630 below.

In step 630, the transaction system 150/key management system 200 derives the Issuer Master Key (e.g. IMKac or KdCVC) using the BIN determined in step 626 and the system level key 500 as stored by the KMS 200. The IMK may be derived using the same process as described in FIG. 4 above.

In step 632, the transaction system 150/key management system 200 derives Card Master Key as per existing processes (as also described above in relation to FIGS. 3 and 4), based on key derivation using the PAN & PSN and the Issuer Master Key 502.

In step 634 the transaction system 150/key management system 200 computes the transaction cryptogram as follows:
a) for EMV payment cytograms: the session key is derived in the key management system 200 in line with the methods described above. Typically this derivation will be based on derivation data of the payment card's Application Transaction Counter (ATC) and the card Master Key. The transaction cryptogram will then be derived by the transaction system 150/key management system 200 based on CDOL1 data using a session key
b) for contactless magstripe payment cryptograms: the transaction cryptogram is generated based on ATC extracted from the received track data.

In step 636, the transaction cryptogram computed in step 634 is compared to the transaction cryptogram received in step 622. In the event that there is a match then the cryptograms are verified and the transaction is authenticated.

Note: in steps 630, 632 and 634 above the transaction system 150/key management system 200 are described as deriving the issuer master key, deriving the card master key and computing the transaction cryptogram. In more detail however, the transaction system 150 acts as a client that requests a Host (or hardware) Secure Module (HSM)—acting as a server—at step 630 to “derive the IMK” (from the system level key), then at 632 to “derive the card master key” (from the IMK that has just been derived), and then at step 634 to “compute the cryptogram” (using the card master key) that is then compared with the cryptogram value produced by the device/card at the terminal.

Effectively, therefore, the HSM acts as a server that performs services for the transaction system 150.

The HSM is a physical computing device that manages a range of cryptographic functions within a payment system 100.

1. A method comprising:
deriving an issuer master key in a transaction system, cryptographic keys within the transaction system being configured within a hierarchical structure with a system level key (SLK) at a top level of the hierarchical structure, wherein deriving the issuer master key in the transaction system comprises:
receiving, at the transaction system, issuer derivation data associated with an issuer; and
deriving the issuer master key from the system level key using the received issuer derivation data, the issuer master key being at a lower level within the hierarchical structure than the system level key.

2. The method of claim 1, wherein the transaction system comprises a digital enablement system having a key management system, the key management system arranged to store the system level key and derive issuer master keys from the stored system level key using the issuer derivation data.

3. The method of claim 2, wherein deriving the issuer master key from the system level key using the received issuer derivation data comprises generating an issuer master key derivation data string and encrypting the data string with the system level key.

4. The method of claim 1, wherein the transaction system comprises more than one system level key, each system level key being associated with a system level key version number and wherein the issuer derivation data comprises a bank identification number (BIN) and the system level key version number.

5. The method of claim 4, wherein the issuer derivation data further comprises a parameter indicating the length of the BIN.

6. The method of claim 5, wherein the system level key version number and the parameter indicating the length of the BIN are combined into a key derivation index parameter, the issuer derivation data comprising the key derivation index parameter.

7. The method of claim 6, wherein each type of transaction being undertaken within the transaction system is associated with a key type identifier.

8. The method of claim 7, wherein the issuer master key derivation data string is 16 bytes long, the first 8 bytes of the string comprising: the key type identifier, the BIN length parameter, the BIN and padding data and the second 8 bytes of the string is the inverse of the first 8 bytes.

9. The method of claim 1, wherein the hierarchical structure of cryptographic keys within the transaction system comprises: the system level key; issuer master keys derived from the system level key; payment device master keys derived from issuer master keys; and session keys derived from payment device master keys.

10. (canceled)

11. The method of claim 1, further comprising:
authenticating a payment device transaction in the transaction system, wherein the transaction system comprises a digital enablement system having a key management system, wherein authenticating the payment device transaction comprises:
receiving transaction data, the transaction data comprising issuer derivation data associated with an issuer, and a transaction cryptogram;
deriving a payment card Master Key using received transaction data and the derived issuer master key;
in the event that the transaction is an EMV transaction:
deriving a session key using the received transaction data and the derived payment card master key; and
generating a transaction cryptogram using the received transaction cryptogram using the session key;
in the event that the transaction is a contactless magstripe transaction: generating the transaction cryptogram based on an application transaction counter (ATC) extracted from the received transaction data; and
authenticating the transaction if the received transaction cryptogram matches the generated transaction cryptogram.

12. The method of claim 11, wherein the transaction data comprises: a primary account number (PAN), a PAN sequence number (PSN) and a key derivation index (KDI), the KDI indicating a system level key version number in use within the transaction system and a Bank Identification Number length parameter.

13. The method of claim 12, wherein the transaction data further comprises: CDOL1 and CDOL data items for EMV transactions, and track data for contactless mag stripe transaction.

14. (canceled)

15. The method of claim 1, further comprising:
digitizing a payment device in a digital enablement system of the transaction system, wherein the issuer master key is derived for the payment device, wherein digitizing the payment device comprises:
receiving payment device data, the payment device data comprising a primary account number (PAN) for the payment device;
deriving a card key using the issuer master key and the PAN of the payment device;
associating, in the digital enablement system, the payment device with the derived card key; and
provisioning the derived card key into a digital wallet.

16. (canceled)

17. A system comprising:
a key management system, cryptographic keys within the system being configured within a hierarchical structure with a system level key (SLK) at a top level of the hierarchical structure, wherein the key management system is arranged to receive issuer derivation data associated with an issuer and derive an issuer master key from the system level key using the received issuer derivation data, the issuer master key being at a lower level within the hierarchical structure than the system level key.

18. The system of claim 17, further comprising a digital enablement system, wherein the key management system is part of the digital enablement system.

19. The system of claim 18, wherein the digital enablement system having the key management system receives transaction data comprising the issuer derivation data, and a transaction cryptogram.

20. The system of claim 19, wherein the digital enablement system having the key management system is further arranged to:
derive a payment card Master Key using the received transaction data and the derived issuer master key;
in the event that the transaction is an EMV transaction:
derive a session key using the received transaction data and the derived payment card master key; and
generate a transaction cryptogram using the received transaction cryptogram using the session key; or
in the event that the transaction is a contactless magstripe transaction: generate the transaction cryptogram based on an application transaction counter (ATC) extracted from the received transaction data; and
authenticate the transaction if the received transaction cryptogram matches the generated transaction cryptogram.

21. The system of claim 18, wherein the digital enablement system receives payment device data, the payment device data comprising a primary account number (PAN) for the payment device;
wherein the key management system is further arranged to derive a card key using the issuer master key and the PAN of the payment device;
wherein the digital enablement system is arranged to associate the payment device with the derived card key and to provision the derived card key into a digital wallet.
